(19) United States
(12) Patent Application Publication
(10) Pub. No.: US 2015/0017035 A1
(43) Pub. Date: Jan. 15, 2015

(54) PUMP HEAD FOR A FUEL PUMP

(71) Applicant: DELPHI INTERNATIONAL OPERATIONS LUXEMBOURG S.A.R.L., BASCHARAGE (LU)

(72) Inventor: Christopher McCrindle, Kings way (GB)

(21) Appl. No.: 14/375,454

(22) PCT Filed: Jan. 29, 2013
(86) PCT No.: PCT/EP2013/051674

§ 371 Date: Jul. 30, 2014

(30) Foreign Application Priority Data
Jan. 30, 2012 (EP) 12153101.6

(51) Int. Cl. F02M 21/02

(52) U.S. Cl. CPC F02M 21/0245
USPC 417/434

(57) ABSTRACT

A pump head for a high-pressure fuel pump is disclosed. The pump head comprises a head housing including a body portion, and a turret portion extending from the body portion, a pumping chamber defined within the body portion, a pumping element bore for receiving a pumping element in use, the pumping element bore extending from the pumping chamber and through the turret portion, and a leakage return passage. The pump head further comprises a sleeve arranged around the turret portion to define a leakage flow path to allow fuel flow from the pumping element bore to the leakage return passage. The pump head is suitable for use in a fuel pump of the type in which a cam drive arrangement of the pump is lubricated by engine oil, since contamination of the engine oil with fuel can be minimised.

### CROSS REFERENCE TO RELATED APPLICATIONS

This application is a national stage application under 35 U.S.C. 371 of PCT Application No. PCT/EP2013/051674 having an international filing date of 29 Jan. 2013, which designated the United States, which PCT application claimed the benefit of European Patent Application No. 12153101.6 filed 30 Jan. 2012, the entire disclosure of each of which are hereby incorporated herein by reference.

### FIELD OF THE INVENTION

The present invention relates to a pump head for a pump. In particular, but not exclusively, the present invention relates to a pump head for a high-pressure fuel pump assembly of the type in which the fuel to be pumped is separated from the drive mechanism of the fuel pump assembly.

### BACKGROUND TO THE INVENTION

In modern common-rail fuel injection systems, and particularly in diesel fuel injection systems, it is desirable to supply fuel to the fuel injectors at very high pressures.

One known type of fuel pump assembly suitable for the supply of fuel to a common rail at high pressure includes at least one pumping element or pumping plunger, which is driven by means of a cam drive arrangement so as to pressurise fuel within a pumping chambers for delivery to the common rail.

The cam drive arrangement includes an eccentric cam surface, rotatable by means of a drive shaft. Rotation of the cam surface is converted to reciprocal linear movement of the plunger by way of an intermediate drive arrangement.

For example, in one known arrangement, the plunger is driven in reciprocal linear movement by means of an associated shoe and roller arrangement. The roller co-operates with the cam surface. The shoe is arranged to cooperate with the plunger such that, as the roller rides over the cam surface, the shoe is driven to cause the plunger to reciprocate within a plunger bore, thereby causing pressurisation of fuel within the associated pumping chamber.

In another known arrangement, a cam follower is provided in the form of a flat tappet, such as a slipper tappet, that cooperates with the plunger. The tappet may cooperate directly with the cam surface, or alternatively drive may be transmitted from the cam surface to the tappet by way of a rider. In a further known arrangement, an end of the plunger is formed into an integral plunger foot, which takes the place of the tappet and cooperates with the cam surface directly or by way of a rider.

In such arrangements, the pumping chamber is typically provided in a pump head of the pump assembly. The pump head includes the plunger bore, in which the plunger is slidably received, and the pumping chamber is defined at an end of the plunger bore. Suitable inlet means, such as an inlet check valve, are provided to admit fuel into the pumping chamber during a filling or return stroke of the plunger, in which the volume of the pumping chamber increases. Suitable outlet means, usually in the form of an outlet check valve, are also provided to discharge fuel at high pressure to the common rail during a pumping or forward stroke of the plunger, in which the volume of the pumping chamber decreases.

Because fuel in the pumping chamber reaches very high pressures, the pump head can be subjected to relatively high, cyclical stresses in use. Accordingly, the pump head must be designed to withstand such stresses and to be resistant to fatigue damage and other modes of failure. Typically, the pump head is formed from a single-piece metal casting that is subsequently machined to form the necessary bores and passages, including the plunger bore and the pumping chamber. The pump head is mounted to a housing of the pump assembly so that one end of the plunger is received in the pump head and the other end of the plunger is received in the housing to cooperate with the cam drive arrangement.

The plunger bore within the pump head acts as a guide for the plunger in use. To maximise the length along which the plunger is guided, a portion of the pump head is typically extended towards the interior of the housing to form a generally cylindrical or frusto-conical turret of the pump head, through which the plunger bore extends. In such an arrangement, a return spring for the plunger, in the form of a compression spring, is typically disposed annularly around the turret. One end of the return spring bears against the pump head, and the other end bears against part of the intermediate drive arrangement so that the spring keeps the intermediate drive arrangement in contact with the cam surface (or the rider) and drives the plunger during its filling stroke.

For some diesel fuel pump applications, diesel fuel is used to lubricate the cam drive arrangement. In other arrangements, it can be desirable for the cam drive arrangement to be lubricated with engine oil or with another lubricating fluid, rather than fuel, to improve durability and performance, particularly in situations where poor-quality fuel could be used. In such cases, undesirable contamination of the engine oil can occur if fuel leaks from the pumping chamber, down the plunger bore into the cam drive mechanism.

EP 1 363 016 A describes a fuel pump assembly having a cam drive mechanism and a pumping plunger received, in part, in a plunger bore of a pump head. An arrangement is provided to capture fuel that leaks from the pumping chamber down the plunger bore, to reduce the risk of fuel reaching the cam drive mechanism, thereby allowing the cam drive mechanism to be lubricated with engine oil.

In particular, in the arrangement disclosed in EP 1 363 016 A, the plunger bore is provided with an annular gallery or collection groove, and a return passage communicates with the collection groove. The return passage is connected to a low-pressure drain, so that fuel that leaks down the plunger bore from the pumping chamber is received by the collection groove and conveyed to the low-pressure drain. This arrangement substantially reduces the amount of fuel that continues down the plunger bore to reach the cam drive mechanism.

To maximise the pumping efficiency, it is desirable to minimise the quantity of fuel that is lost to the low-pressure drain in such an arrangement. However, with higher pumping pressures, fuel leakage down the plunger bore tends to increase, leading to an undesirable loss of efficiency.

Against this background, it would be desirable to provide a pump assembly having an improved arrangement for reducing leakage of fuel into the cam drive mechanism.

### SUMMARY OF THE INVENTION

According to a first aspect of the present invention, there is provided a pump head for a high-pressure fuel pump, comprising a head housing including a body portion and a turret portion extending from the body portion, a pumping chamber defined within the body portion, and a pumping element bore for receiving a pumping element in use, and a leakage return passage. The pumping element bore extends from the pumping chamber and through the turret portion. The pump head further comprises a sleeve arranged around the turret portion to define a leakage flow path to allow fuel flow from the pumping element bore to the leakage return passage. The pump further comprises at least one through-passage extending through the turret portion between the pumping element bore and the leakage flow path. The or each through-passage communicates with a collection groove provided in the pumping element bore in the turret portion or in the pumping element.

By providing a sleeve to define the leakage flow path, it is possible to capture leakage fuel from the pumping element bore at a position within or at the end of the turret portion, at a relatively large distance from the pumping chamber, thus minimising the impact of the invention on the volumetric efficiency of the pump. Furthermore, because the leakage flow path can be defined between the turret portion and the sleeve, is not necessary to provide drillings or passages within the turret portion itself, thereby avoiding any significant detriment to the strength and fatigue resistance of the pump head. Accordingly, the leakage return passage may be defined within the body portion, in which case the leakage return passage may not extend into the turret portion.

The body portion may comprise a mounting face for mounting to a housing of the fuel pump in use, and the leakage return passage may open onto the mounting face adjacent to the turret portion.

The leakage return passage is preferably positioned so as to minimise stress concentrations within the pump head. For example, the leakage return passage may be inclined at approximately 45° to the pumping element bore.

Preferably, the leakage flow path comprises an annular space between the sleeve and the turret portion. This arrangement provides a relatively large cross-sectional area for leakage flow, yet the annular space and the sleeve itself can be relatively thin in the radial direction so as not to increase significantly the diameter of the turret portion. In this way, a leakage flow path can be provided without substantial modifications to the dimensions of the pump head or the packaging of the pump.

Optionally, the or each through-passage extends radially through the turret portion. The collection groove, which may for example be annular or arcuate, serves to collect fuel that leaks along the pumping element bore in use. Alternatively, or in addition, a collection groove may be provided in the pumping element of the fuel pump with which the pumping head is used, in which case the collection groove in the pumping element may be registrable with the or each through-passage during at least a part of the pumping cycle.

The sleeve may comprise a sealing member disposed adjacent to an end face of the turret portion for receiving the pumping element therethrough, to reduce or prevent leakage of fuel that escapes from the turret portion. In an advantageous arrangement, the sealing member is spaced from the end face of the turret portion to define a radial flow path therebetween allowing flow from the plunger bore to the leakage flow path. The radial flow path may be provided instead of or in addition to one or more through-bores in the turret portion.

The sleeve preferably comprises engaging means for engaging the turret portion. The engaging means assist in the correct positioning of the sleeve with respect to the turret portion, and in particular help to ensure that the sleeve is positioned coaxially with respect to the turret portion. In one example, the engaging means comprises a reduced-diameter portion of the sleeve which forms an interference fit with a distal end region of the turret portion. In another example, the engaging means comprises a plurality of axially-extending indentations in the sleeve which engage with the turret portion.

The pump head may further comprise sealing means which cooperate with the sleeve and with the body portion of the housing to prevent fuel flow between the sleeve and the body portion. For example, the sealing means may comprise an outwardly-directed flange region of the sleeve, optionally with a sealing member in the form of an O-ring.

Similarly, the sleeve may comprise an outwardly-extending flange at a proximal end thereof, and the flange may define a spring seat for a return spring of the pump. In this way, the return spring helps to retain the sleeve in position, in use.

The present invention also extends, in a second aspect, to a fuel pump comprising a pump head according to the first aspect of the invention, a pumping element slidably received within the pumping element bore, and a drive mechanism for driving the pumping element in reciprocal linear movement to increase and decrease the volume of the pumping chamber.

According to a third aspect of the present invention, there is provided a pump head for a high-pressure fuel pump, comprising a head housing including a body portion and a turret portion extending from the body portion, a pumping chamber defined within the body portion, and a pumping element bore for receiving a pumping element in use, and a leakage return passage. The pumping element bore extends from the pumping chamber and through the turret portion. The pump head further comprises a sleeve arranged around the turret portion to define a leakage flow path to allow fuel flow from the pumping element bore to the leakage return passage. The pumping element bore communicates with an annular space, the annular space being defined by the sleeve.

The pumping head may comprise a seal member disposed adjacent to an end face of the turret portion.

The pumping plunger bore may communicate with the annular space by way of a gap between the seal member and the end face of the turret portion. The gap may define a radial flow path for allowing flow from the plunger element bore to the leakage flow path.

Proposed and/or optional features of the first aspect of the invention may also be used, alone or in appropriate combination, in the second aspect and/or the third aspect of the invention also.

### BRIEF DESCRIPTION OF THE DRAWINGS

The present invention will now be described, by way of example only, with reference to the accompanying drawings, in which like reference numerals are used for like features, and in which:

FIG. 1 is a cross-sectional view of part of a pump assembly having a pump head according to a first embodiment of the present invention;

FIG. 2 is an enlarged cross-sectional view showing part of the pump assembly of FIG. 1 in greater detail;

FIG. 3 is a cross-sectional view showing part of a pump assembly having a pump head according to a second embodiment of the present invention; and

FIG. 4 is a cross-sectional view showing part of a pump assembly having a pump head according to a third embodiment of the present invention.

Throughout this specification, terms such as ‘upper’ and ‘lower’ are used with reference to the orientation of the components as shown in the accompanying drawings. It will be appreciated, however, that the components could be disposed in a different orientation in use.

### DETAILED DESCRIPTION OF EMBODIMENTS OF THE INVENTION

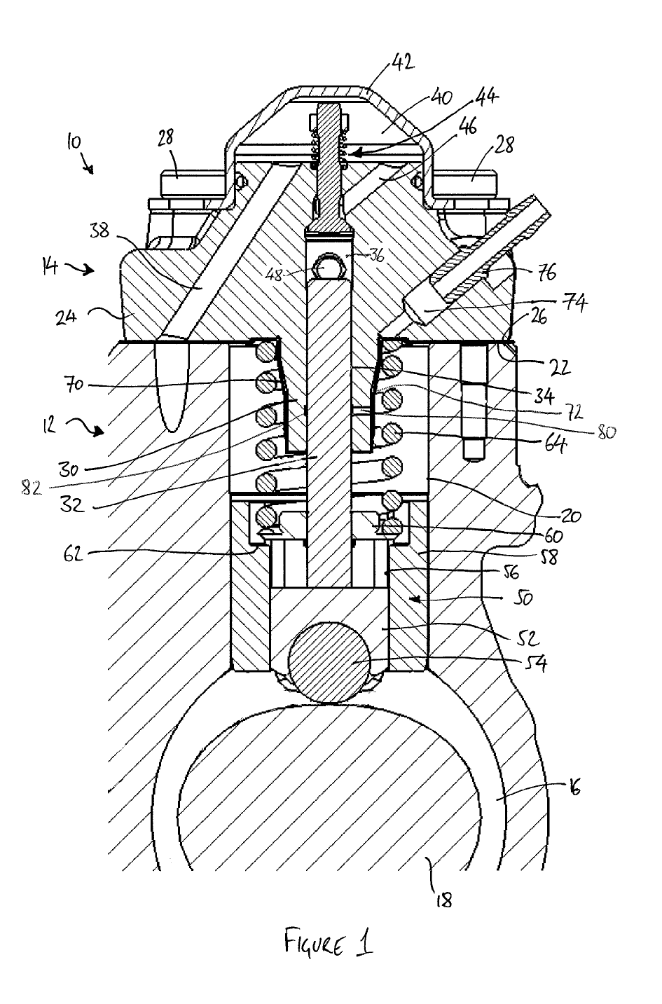

Referring to FIG. 1 of the accompanying drawings, a fuel pump assembly 10 is provided which comprises a pump housing 12, only part of which is shown in FIG. 1, and a pump head 14 attached to the pump housing 12.

The pump housing 12 defines a chamber or internal volume 16 that houses a cam 18 which is driven by a drive shaft (not shown). The cam 18 and the drive shaft together form part of a cam drive mechanism. A cylindrical port 20 extends from the internal volume 16 to a mounting surface 22 of the pump housing 12.

The pump head 14 comprises a housing body portion 24, which is mounted outside the pump housing 12 and which defines a mounting surface 26 of the pump head. The pump head 14 is attached to the pump housing 12 by way of suitable fasteners 28, which serve to clamp the respective mounting surfaces 22, 26 of the pump housing 12 and the body portion 24 of the pump head 14 to one another, thereby to close and seal the port 20.

The pump head 14 further comprises a housing turret portion 30, which projects from the mounting surface 26 of the body portion 24. The turret portion 30 extends into the port 20 in the pump housing 12, towards the internal volume 16.

A pumping element in the form of a pumping plunger 32 is slidably received, in part, within a plunger bore 34 of the pump head 14. The plunger bore 34 is a blind bore that extends through the turret portion 30 and into the body portion 24 of the pump head 14. A pumping chamber 36 is provided at the blind end of the plunger bore 34, such that the pumping chamber 36 is defined in part by the plunger bore 34 and in part by an upper end of the plunger 32.

Fuel is supplied to the pumping chamber 36 from a fuel reservoir (not shown) by way of an entry drilling 38, an external chamber 40 defined by a cap 42 of the pumping head 14, and an inlet valve arrangement 44 supplied from the external chamber 40 by a feed drilling 46. Fuel can leave the pumping chamber 36 by way of an exit drilling 48 which communicates with an outlet valve arrangement (not shown).

The lower end of the plunger 32, opposite the pumping chamber 36, cooperates with an intermediate drive assembly 50 of the cam drive mechanism. In this embodiment, the intermediate drive assembly 50 includes a cam follower arrangement comprising a shoe 52 that cooperates with the end of the plunger 32 and a roller 54 which cooperates with the surface of the cam 18. The shoe 52 is received in the central bore 56 of a generally tubular shoe guide 58, and the shoe guide 58 is received in the port 20 in the pump housing 12. As the cam 18 rotates, the roller 54 and the shoe 52 are forced upwardly to drive the plunger 32 in its pumping stroke, which compresses fuel in the pumping chamber 36 and forces it out of the exit drilling 48 to the outlet valve.

A ring-shaped collar 60 is disposed around the plunger 32 and within the upper end of the bore 56 of the shoe guide 58. The collar 60 is a press-fit onto the plunger. Near its upper end, the bore 56 of the shoe guide 58 is stepped to define a shoulder 62, and the collar 60 is spaced from the shoulder 62 so that lubricating fluid can flow freely into the bore 56 of the shoe guide 58. A return spring 64, in the form of a compression spring, is provided within the port 20. The plunger 32 extends through the return spring 64, and the spring 64 acts on the collar 60 to keep the roller 54 in contact with the cam 18 and to drive the plunger 32 in its return stroke, causing fuel to refill the pumping chamber 36 through the inlet valve arrangement.

In use, particularly during the pumping stroke, fuel tends to leak from the pumping chamber 36 between the plunger 32 and the plunger bore 34. As will now be explained, the present invention provides means for collecting such leakage fuel before it enters the port 20, thereby minimising the amount of fuel that leaks into the port 20 and the internal volume 16 of the pump housing 12. This allows the cam drive mechanism to be lubricated with a fluid other than fuel, such as engine oil.

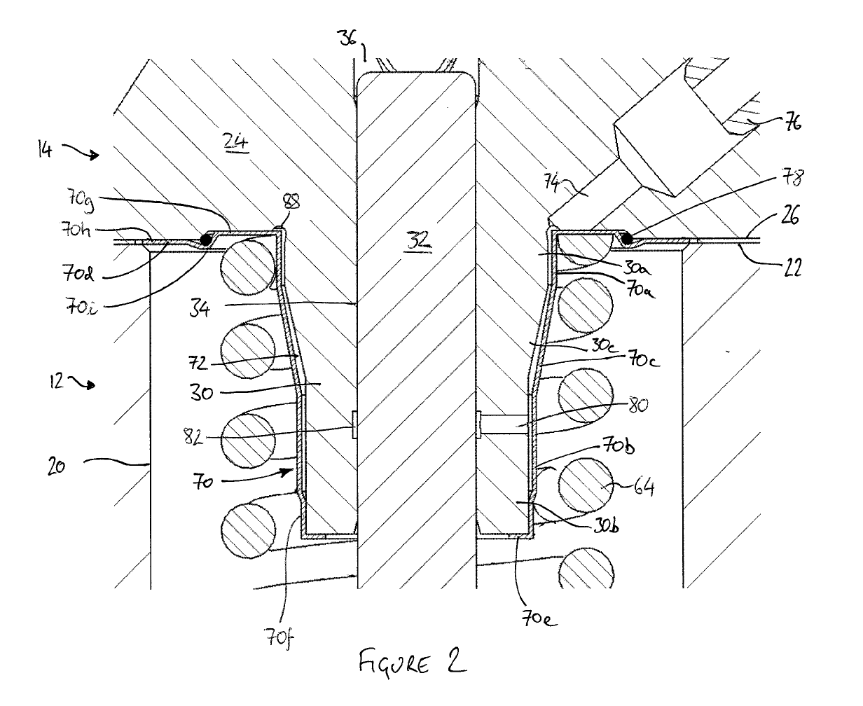

Referring additionally to FIG. 2, the turret portion 30 of the pump head 14 is provided with a cap or sleeve 70. The turret portion 30 has a relatively large diameter tubular region 30a at its proximal end, adjacent to the body portion 24, a smaller diameter tubular region 30b at its distal end, furthest from the body portion 24, and a frustoconical intermediate region 30c connecting the two tubular regions. The sleeve 70 has a generally complementary shape to the outside of the turret portion 30, and therefore comprises a relatively large diameter tubular region 70a at its proximal end, a relatively small diameter tubular region 70b at its distal end, and a frustoconical intermediate region 70c. In addition, the sleeve 70 also comprises an outwardly-extending flange region 70d at the proximal end of the sleeve 70, and an inwardly-extending flange region 70e at the distal end of the sleeve 70.

The tubular regions 70a, 70b and the intermediate region 70c of the sleeve 70 have a larger internal diameter than the external diameter of the corresponding regions 30a, 30b, 30c of the turret portion 30, such that an annular space 72 is defined between the outside of the turret portion 30 and the inside of the sleeve 70 along the length of the sleeve 70.

The annular space 72 defines a leakage flow path for fuel, and communicates, at its upper end, with a leakage return passage 74 which extends from the mounting surface 26 of the body portion 24 of the pump head 14. The leakage return passage 74 is inclined at an angle of approximately 45° to the axis of the plunger bore 34. The leakage return passage 74 is provided with a connector 76 (shown most clearly in FIG. 1) to allow a return line (not shown) to be connected to the leakage return passage 74 in use. The leakage return passage 74 is connected in use to a low-pressure fuel drain, such as the fuel reservoir.

Referring again to FIG. 2, the distal tubular region 70b of the sleeve 70 includes, at its lower end, a reduced-diameter portion 70f which engages with the lower part of the distal tubular region 30b of the turret portion 30 in a close interference fit. The reduced diameter portion 70f and the inwardly-directed flange region 70e together serve to close the lower end of the annular space 72, thereby substantially preventing leakage from the annular space 72 into the port 20 between the sleeve 70 and the turret portion 30.

The outwardly-directed flange region 70d of the sleeve 70 abuts the mounting surface 26 of the body portion 24 of the pump head 14. The flange region 70d is stepped to define an inner annular portion 70g and an outer annular portion 70h, and the mounting surface 26 of the body portion 24 of the pump head 14 is shaped such that both the inner and outer annular portions 70g, 70h lie flat against the mounting surface 26. The return spring 64 acts against the inner annular portion 70g of the flange region 70d, and thereby serves to retain the sleeve 70 in position against the body portion 24 and around the turret portion 30 of the pump head 14.

The step 70i between the inner and outer annular portions 70g, 70h provides a seating for an O-ring 78, which forms a sealing means to prevent leakage from the annular space 72 to the port 20 between the sleeve 70 and the body portion 24.

The annular space 72 is in communication with the plunger bore 34 by way of a through-passage 80 that extends radially through the turret portion 30. Although only one through-passage 80 is shown in FIGS. 1 and 2, it will be appreciated that more than one such passage 80 could be provided. The through-passage 80 opens into an annular groove or channel, known hereafter as a collection groove 82, formed in the plunger bore 34 within the distal region 30b of the turret portion 30.

In use, when fuel leaks from the pumping chamber 36 between the plunger 32 and the plunger bore 34, fuel flow down the plunger bore 34 is interrupted by the collection groove 82. Since the leakage return passage 74 is maintained at a relatively low pressure relative to the pressure of the leakage fuel in the plunger bore 34 during the pumping stroke, the fuel that collects in the collection groove 82 tends to flow through the through-passage 80, into the annular space 72, and out of the pumping head 14 through the leakage return passage 74, instead of continuing down the plunger bore 34. In this way, the quantity of fuel that leaks into the port 20 and the internal volume 16 of the pump housing 12 is minimised.

Advantageously, since the collection groove 82 is disposed in the turret portion 30 of the pump head 14, and more particularly in the distal region 30b of the turret portion 30, the distance between the pumping chamber 36 and the collection groove 82 is longer than would be the case if the collection groove 82 were instead disposed in the body portion 24 of the pump head 14. The pressure drop along the plunger bore 34 increases with distance from the pumping chamber 36, and therefore by maximising the distance between the pumping chamber 36 and the collection groove 82, the quantity of pressurised fuel that leaves through the leakage return passage 74 is minimised. In this way, the volumetric efficiency of the pump assembly can be maximised.

To preserve the ability of the pump head 14 to resist the substantial loads experienced during pumping, for example due to fuel pressure in the pumping chamber 36 and due to side loads on the plunger 32, the collection groove 82 and the through-passage 80 are preferably spaced away from the distal end of the turret portion 30. In other words, the positions of the collection groove 82 and the through-passage 80 are a compromise between minimising wastage of pressurised fuel and maintaining the strength of the pump head 14.

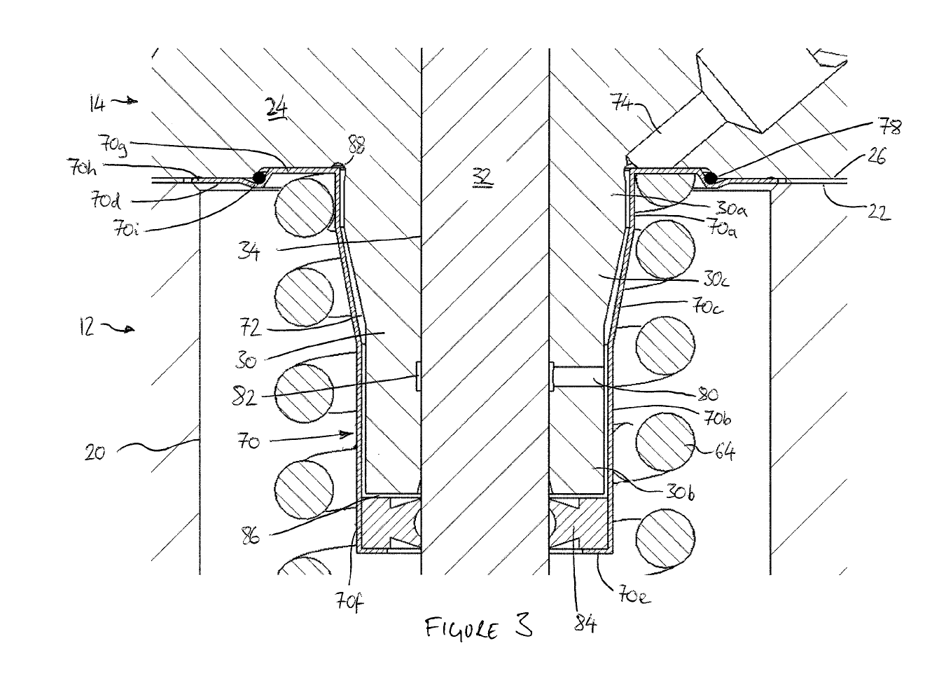

FIG. 3 shows a second embodiment of the present invention. The pump head shown in FIG. 3 is similar to the first embodiment shown in FIGS. 1 and 2, with like reference numerals used for like parts, and only the differences between the second embodiment and the first embodiment will be described in detail.

In the second embodiment of the invention, the distal tubular region 70d of the sleeve 70 is extended beyond the end of the turret portion 30 of the pump head 14, so that the inwardly-directed flange region 70e is spaced from the end of the turret portion 30. An annular seal member 84 is disposed around the plunger and is retained in the space between the end of the turret portion 30 and the inwardly-directed flange region 70e. A gap 86 between the seal member 84 and the end of the turret portion 30 allows fuel to flow in a radial direction from the end of the plunger bore 34 into the annular space 72, thereby supplementing the flow through the through-drilling 80, and decreasing further the amount of fuel that leaks from the plunger bore 34 into the port 20.

Unlike in the first embodiment of the invention, in this second embodiment the distal tubular region 70b of the sleeve 70 does not include a reduced-diameter portion at its lower end, since this would block the flow of fuel from the gap 86 into the annular space 72. Instead, to retain the sleeve 70 in the correct coaxial position with respect to the turret portion 30, a plurality of angularly-spaced, axially-extending corrugations or indentations (not shown) are provided on the distal tubular region 70b or, alternatively or in addition, on the proximal tubular region 70a to engage with the outer surface of the turret portion 30 whilst allowing flow between the indentations.

The seal member 84 is of any suitable type. For example, the seal member 84 may be made from PTFE filled with graphite, which combination of materials provides good wear resistance and a low coefficient of friction to aid sliding movement of the plunger 34 through the central bore of the seal member 84. The seal member 84 may be a plain annular washer or, as illustrated in FIG. 3, the seal member 84 may be formed with resilient structures to keep the surface of the seal member 84 in contact with the plunger 34.

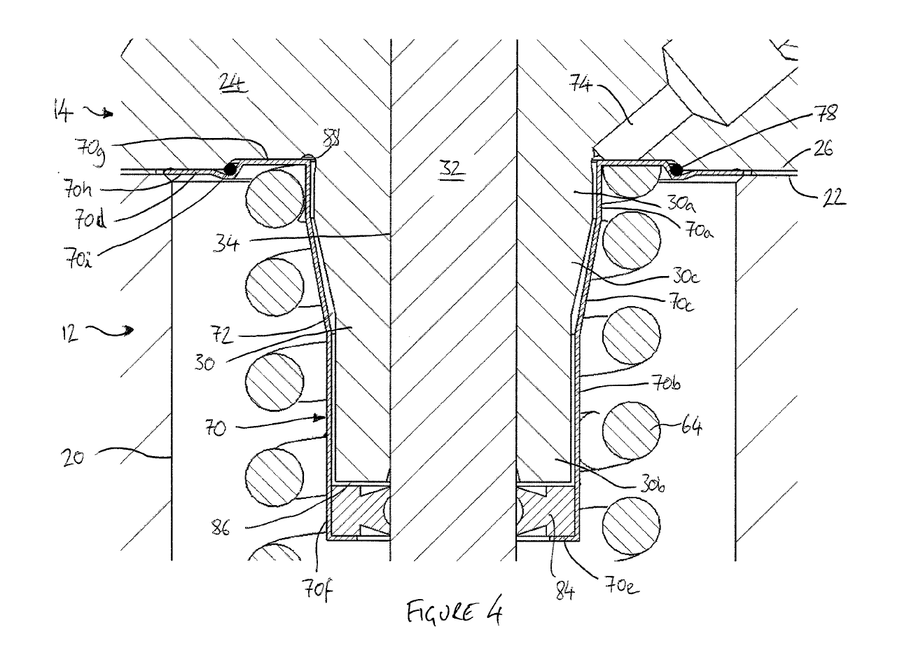

FIG. 4 shows a third embodiment of the present invention. The pump head shown in FIG. 4 is similar to the second embodiment shown in FIG. 3, with like reference numerals used for like parts, and only the differences between the third embodiment and the second embodiment will be described in detail.

In this third embodiment, the collection groove and the through-bore are omitted, and instead the plunger bore 34 communicates with the annular space 72 defined by the sleeve 70 only by way of the gap 86 between the seal member 84 and the end of the turret portion 30. In this embodiment, because the distance between the pumping chamber 36 and the gap 86 is maximised, the quantity of pressurised fuel that escapes from the pump head 14 through the leakage return passage 74 is minimised.

In each of the described embodiments, the design of the pump head 14 is adapted to minimise stress concentrations within the pump head 14 in order to maximise its strength and avoid fatigue damage under the cyclical pumping loads. For example, the turret portion 30 meets the body portion 24 of the pump head 14 at a radiused groove 88, so as to avoid the presence of a sharp corner at this point.

The arrangement of the leakage return passage 74 at approximately 45° to the axis of the plunger bore 34 also helps to reduce stress concentrations. It will be appreciated, however, that the leakage return passage 74 could be arranged in a different orientation with respect to the plunger bore 34. Also, since the sleeve 70 provides an annular space 72 in the illustrated examples, the leakage return passage 74 can be arranged at any suitable angular position within the pump head 14.

Because a sleeve 70 is provided to define a leakage flow path for fuel from the plunger bore 34 to the leakage return passage 74, in the present invention it is not necessary to form any passages in the turret portion 30 of the pump head 14, other than the radial through-drillings 80 when present. As a result, the wall thickness of the turret portion 30 can be thinner than would be required if other drillings were present. Furthermore, the sleeve 70 is relatively thin and does not substantially increase the effective diameter of the turret portion 30. These factors mean that the space available to accommodate the return spring 64 is not compromised by the arrangement of the present invention.

In that context, it is particularly advantageous that the leakage return passage 74 in the illustrated embodiments extends only within the body portion 24 of the pump head 14, and does not intrude into the turret portion 30.

In the illustrated examples, the leakage flow path defined by the sleeve 70 is in the form of an annular space 72, which provides a large flow area for fuel flow even though the space is small in the radial direction. However, it will be appreciated that the leakage flow path need not be annular, but could instead be formed as one or more distinct channels or passages defined, at least in part, by the sleeve. For instance, the sleeve could be a close fit to the turret, with grooves formed in the inside surface of the sleeve to form the channels. In another arrangement, the leakage flow path could be defined in part by grooves or channels formed in the outer surface of the turret portion, in which case the sleeve could again be a close fit to the turret. Grooves or channels in the inside surface of the sleeve and/or the outside surface of the turret could be generally axially directed, or could for instance be arranged in a helical configuration.

It will be appreciated that fuel flowing in the leakage flow path 74 in the arrangement of the present invention can be exposed to a relatively large surface area of the inside surface of the sleeve 70, and that, in turn, a relatively large surface area of the outside surface of the sleeve 70 is exposed to lubricating fluid, such as engine oil, within the port 20. Advantageously, therefore, the fuel flowing back to the low pressure reservoir by way of the leakage flow path 72, which is heated by compression in the pumping chamber 36, can be cooled by the lubricating fluid in the port 20 even though the fuel and the lubricating fluid remain physically separated. To this end, in one embodiment of the invention, means for directing lubricating fluid towards the outer surface of the sleeve 70 are provided. For instance, the pump housing 12 may be provided with means to direct one or more jets of lubricating fluid towards the outer surface of the sleeve 70. Suitable means include oilways in the pump housing 12 which open into the port 20 at an appropriate position and angle.

In the illustrated embodiments, the leakage return passage 74 is connected to a low pressure reservoir by way of the connector 76. In an alternative arrangement, the leakage return passage 74 may communicate with the external chamber 40 of the pump head 14, for example by way of one or more further passages in the body portion 24 of the pump head 14. In such an arrangement, fuel leaking down the plunger bore 34 is returned directly to the inlet means of the pump.

It will be appreciated that it is preferable to avoid reverse flow of fuel through the leakage return passage 74 towards the annular space 72. Accordingly, means for preventing reverse flow, such as a check valve, and/or means for reducing the pressure in the leakage return passage 74, such as a Venturi device or an auxiliary pump, may be provided.

In another embodiment of the present invention, the annular collection groove shown in FIGS. 1 to 3 is not present, and instead one or more through-passages 80 open directly into the plunger bore 34. In another embodiment, a collection groove is formed in the plunger 32, and the collection groove is registrable with the or each through-passage 80 during at least a part of a pumping cycle of the plunger 32.

The sleeve 70 may be of any suitable material, and may be formed by any suitable manufacturing method. In one example, the sleeve 70 is of metal and is formed by deep-drawing.

The shape and configuration of the sleeve 70 may differ from that described above with reference to the illustrated embodiments. For example, in one alternative configuration, the outwardly-extending flange region 70d has a larger diameter than in the illustrated embodiments, and extends between the mounting surface 26 of the body portion 24 of the pump head 14 and the mounting surface 22 of the pump housing 12. In this arrangement, the flange region 70d of the sleeve 70 plays a role in effecting sealing between the pump head 14 and the pump housing 12.

It will be appreciated that, although an intermediate drive assembly 50 in the form of a roller shoe arrangement is described, the present invention is equally applicable to pump arrangements having alternative intermediate drive assemblies 50, such as slipper tappet arrangements and integral plunger foot arrangements. Indeed, by providing a reliable means of ensuring that fuel does not contaminate the fluid used to lubricate the cam drive mechanism, the present invention permits the use of intermediate drive assembly types that require enhanced lubrication compared to that possible using fuel as a lubricant.

Several further variations and modifications not explicitly described above are also possible without departing from the scope of the invention as described in the appended claims.

1. A pump head for a high-pressure fuel pump, comprising:
a head housing including a body portion extending from the body portion;
a pumping chamber defined within the body portion;
a pumping element bore for receiving a pumping element in use, the pumping element bore extending from the pumping chamber and through the turret portion; and
a leakage return passage;
wherein the pump head further comprises:
a sleeve arranged around the turret portion to define a leakage flow path to allow fuel flow from the pumping element bore to the leakage return passage; and
at least one through-passage extending through the turret portion between the pumping element bore and the leakage flow path;
characterised in that the or each through-passage communicates with a collection groove provided in the pumping element bore in the turret portion, or in the pumping element.

2. A pump head according to claim 1, wherein the leakage return passage is defined within the body portion.

3. A pump head according to claim 1, wherein the body portion comprises a mounting face for mounting to a housing of the fuel pump in use, and wherein the leakage return passage opens onto the mounting face adjacent to the turret portion.

4. A pump head according to claim 1, wherein the leakage return passage is inclined at approximately 45° to the pumping element bore.

5. A pump head according to claim 1, wherein the leakage flow path comprises an annular space between the sleeve and the turret portion.

6. A pump head according to claim 1, wherein the or each through-passage extends radially through the turret portion.

7. A pump head according to claim 1, wherein the sleeve comprises a sealing member disposed adjacent to an end face of the turret portion for receiving the pumping element therethrough.

8. A pump head according to claim 7, wherein the sealing member is spaced from the end face of the turret portion to define a radial flow path therebetween allowing flow from the plunger bore to the leakage flow path.

9. A pump head according to claim 1, wherein the sleeve comprises engaging means for engaging the turret portion.

10. A pump head according to claim 9, wherein the engaging means comprises a reduced-diameter portion of the sleeve which forms an interference fit with a distal end region of the turret portion.

11. A pump head according to claim 1, further comprising sealing means which cooperate with the sleeve and with the body portion of the housing to prevent fuel flow between the sleeve and the body portion.

12. A pump head according to claim 1, wherein the sleeve comprises an outwardly-extending flange at a proximal end thereof, and wherein the flange defines a spring seat for a return spring of the pump.

13. A fuel pump comprising: a pump head according to claim 1, a pumping element slidably received within the pumping element bore, and a drive mechanism for driving the pumping element in reciprocal linear movement to increase and decrease the volume of the pumping chamber.
